(19) United States
(12) Patent Application Publication
(10) Pub. No.: US 2007/0070507 A1
(43) Pub. Date: Mar. 29, 2007

(54) Aspherical microlens arrays and fabrication method thereof and applications using the same

(76) Inventors: Young-Joo Yee, Gyeonggi-Do (KR); Gun-Woo Lee, Daegu (KR); Ki-Won Park, Gyeonggi-Do (KR); Dong-Mug Seong, Gyeonggi-Do (KR)

Correspondence Address: BIRCH STEWART KOLASCH & BIRCH, PO BOX 747, FALLS CHURCH, VA, 22040-0747, US

(21) Appl. No.: 10/583,965

(22) PCT Filed: Dec. 23, 2004
(86) PCT No.: PCT/KR04/03425

§ 371 Date: Jun. 21, 2006

(30) Foreign Application Priority Data
Dec. 23, 2003 (KR) 10-2003-0095707

(51) Int. Cl. G02B 27/10

(52) U.S. Cl. 359/622

(57) ABSTRACT

An aspherical microlens arrays comprise a base, and a plurality of aspherical microlens arranged on the base and having different curvature radiuse and conic coefficient respectively, along two orthogonal axes on the base perpendicular to an optical axis, by which a degree of refraction, namely, a numerical aperture can be easily adjusted depending on each axial direction, a spherical aberration can be reduced, and concentration efficiency can be improved. In addition, in case of applying the aspherical microlens arrays to a projection screen, an image sensor, or the like, it is advantageous to improve sensitivity and resolution thereof.

### TECHNICAL FIELD

The present invention relates to aspherical microlens arrays, a fabricating method therefor and applications using the same, and more particularly to aspherical microlens arrays capable of having a collimating function and an angular field of view improved by differently adjusting a curvature radius and a conic coefficient, separately, along two orthogonal axes on a plane surface perpendicular to an optical axis, a fabricating method therefor and applications using the same.

### BACKGROUND ART

In general, a microlens arrays are usually used for a projection screen which enables a user to see a wide screen by enlarging and projecting a tiny image formed in a cathode-ray tube (CRT) or a liquid crystal display (LCD) on the projection screen. Also, it is a trend that its applicable fields are being gradually extended.

FIGS. 1 to 3 illustrate an embodiment of a conventional microlens arrays applied to the projection screen. That is, FIG. 1 is a schematic diagram showing a structure of the conventional projection screen FIG. 2 is a front view showing a lenticular microlens arrays of FIG. 1 and FIG. 3 is side cross-sectional view taken along a cross-sectional line III-III.

As shown in those drawings, the conventional projection screen consists of a microlens array sheet 10 at which a plurality of lenticular microlenses 11 are arranged and a Fresnel lens plate 20. The microlens array sheet 10 includes a substrate 12 for arranging the plurality of lenticular microlenses thereon; a black matrix layer 13 for forming a clear aperture on the substrate; an optical scattering layer 14 formed of optical scattering particles in order to enlarge an angular field of view; and a protecting film 15 formed at one surface of the optical scattering layer 14 as a transparent resin film in order to protect the optical scattering layer 14.

And, the Fresnel lens plate 20 consists of a Flesnel lens substrate 21 for supporting a Flesnel's lens 22; and the Fresnel's lens 22 symmetrically formed on the basis of the center of a screen, for performing a function as a collimate lens for converging a collimated beam.

However, a lens used for the projection screen which uses the conventional liquid crystal display or a digital light processor as an image source, as can be seen from FIGS. 2 and 3, is a lenticular microlens 11 parallel-arranged as a hemicylindrical shape. Thus, the lens can collimate light only along one axis at which a sphere has been formed so that it may have an angular field of view corresponding to a numerical aperture (NA) with respect to a horizontal direction of incident light, while the lens should depend on an auxiliary equipment such as an optical scattering layer 14 to ensure an angular field of view for an axis without a sphere formed. However, a light efficiency of overall optical system may be degraded and a brightness may be also decreased because of a light loss due to a scattering inevitably occurred when using the optical scattering layer 14. Moreover, the addition of the auxiliary equipment such as the optical scattering layer 14 may cause an increase of costs.

FIGS. 4 and 5 illustrate another embodiment of the conventional microlens arrays in order to solve problems of the microlens arrays having the hemicylinder-shaped lenticular lens.

FIG. 4 is a front view showing an ellipse-shaped spherical microlens arrays, and FIG. 5 is a side cross-sectional view, taken along a cross-sectional line V-V of FIG. 4.

As shown in FIGS. 4 and 5, the conventional microlens arrays in accordance with another embodiment include a plurality of ellipse-shaped spherical microlenses 31 arranged on a transparent substrate 32.

Unlike the hemicylinder-shaped lenticular lens having a curved surface in one axial direction on a plane surface perpendicular to an optical axis, since the spherical microlens arrays are formed as curved surfaces along two orthogonal axes on the plane surface perpendicular to the optical axis, considerable level of angular field of view can be guaranteed and overall optical efficiency can be improved.

However, the conventional spherical microlens arrays are formed having a certain curvature radius along the two orthogonal axes. According to this, a rate of an angular field of view therefor according to each axis becomes the same. As a result of this, when they are applied to an optical system such as a projection screen, a quantity of light more than to be required is discharged toward a perpendicular direction of a screen with respect to an earth surface, that is, the quantity of light of a horizontal direction of the screen with respect to the earth surface is consumed as much as the quantity of the perpendicular direction, so that brightness of the horizontal direction is deteriorated.

Moreover, when the conventional spherical microlens arrays are applied to an image sensor, an optical integration performance is so low as to degrade sensitivity, resolution and reaction of the image sensor.

### DISCLOSURE OF THE INVENTION

Therefore, it is an object of the present invention to provide aspherical microlens arrays capable of improving an optical efficiency by differently adjusting a curvature radius and a conic coefficient, separately, along two orthogonal axes on a plane surface perpendicular to an optical axis, and a fabricating method therefor.

According to another embodiment of the present invention, there is provided applications of the aspherical microlens arrays.

To achieve those objects, there is provided aspherical microlens arrays comprising a base and a plurality of aspherical microlenses arranged on the base.

According to another embodiment of the present invention, there is provided a method for fabricating an aspherical microlens arrays, the method comprising a first step of fabricating a first mold having spherical groove arrays with different curvature radius, respectively, along two orthogonal axes to each other on one surface; a second step of fabricating spherical microlens arrays capable of elastic deformation using the first mold; a third step of fabricating aspherical microlens arrays having different curvature radiuses and conic coefficients, respectively, along two orthogonal axes on one surface by providing elongated force to the elastically-deformable spherical microlens arrays; a fourth step of fabricating a second mold having an aspherical groove arrays, namely, a reversed phase of the aspherical microlens arrays on its one surface; and a fifth step of reproducing the aspherical microlens arrays using the second mold.

According to still another embodiment of the present invention, there is provided a projection screen including; an aspherical microlens arrays having a plurality of aspherical microlenses arranged on the base; a black matrix layer formed at an opposite surface to the certain surface of the base at which the microlenses have been formed and having an array structure of a clear aperture corresponding to the respective microlenses; and a Fresnel's lens installed at a position facing the microlens, for applying collimated beam to the microlens arrays.

According to yet another embodiment of the present invention, there is provided an image sensor including an image processing unit; and an aspherical microlens arrays coupled to one side of the image processing unit and having a plurality of aspherical microlenses arranged on the base, for improving a degree of integration of light incident onto the image processing unit.

Objects and configurations of the aspherical microlens arrays, the fabricating method therefor and applications using the same according to the present invention will be more precisely understood by a detail explanation with respect to preferred embodiments based on accompanying drawings.

### BRIEF DESCRIPTION OF THE DRAWINGS

FIG. 1 is a schematic diagram illustrating a structure of a conventional projection screen;

FIG. 2 is a front view illustrating a conventional microlens arrays according to an embodiment;

FIG. 3 is a cross-sectional side view, taken along cross-sectional line III-III of FIG. 2;

FIG. 4 is a front view illustrating the conventional microlens arrays according to another embodiment;

FIG. 5 is a side view, taken along cross-sectional line V-V of FIG. 4;

FIG. 6 is a perspective view illustrating an aspherical microlens arrays in accordance with an embodiment of the present invention;

FIG. 7 is a side view, taken along cross-sectional line VII-VII of FIG. 6;

FIG. 8 is a side view, taken along cross-sectional line VIII-VIII of FIG. 6;

FIG. 9 is a perspective view illustrating an aspherical unit microlens in accordance with an embodiment of the present invention;

FIG. 10 is a side view, taken along cross-sectional line X-X of FIG. 9;

FIG. 11 is a side view, taken along cross-sectional line XI-XI of FIG. 9;

FIG. 12 through 22 illustrate fabrication flows of an aspherical microlens arrays in accordance with an embodiment of the present invention;

FIG. 23 is a perspective view illustrating the aspherical microlens arrays of FIG. 22;

FIG. 24 illustrates a configuration of a projection screen to which an aspherical microlens arrays in accordance with an embodiment of the present invention is applied;

FIG. 25 is a disassembled perspective view of an aspherical microlens arrays assembly of FIG. 22; and

FIG. 26 is a perspective view illustrating an aspherical unit microlens applied to a projection screen.

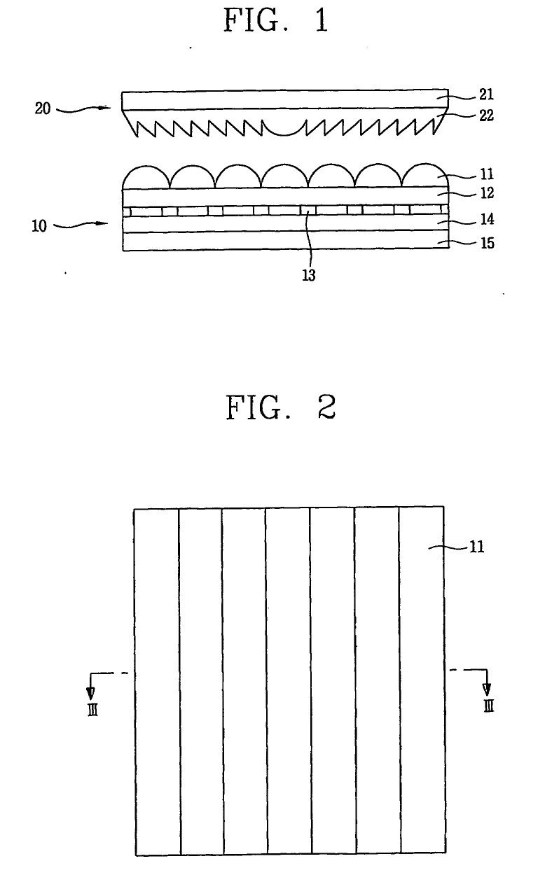

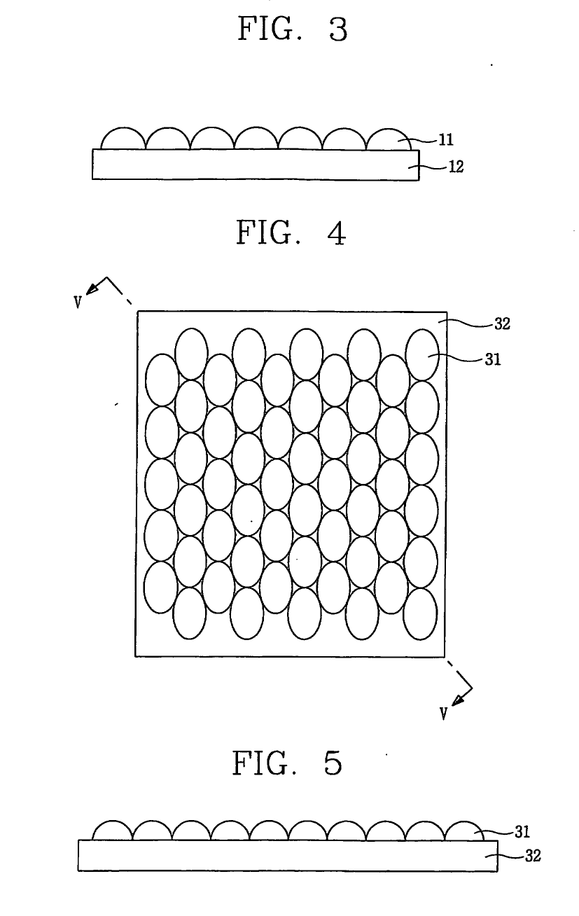

### MODES FOR CARRYING OUT THE PREFERRED EMBODIMENTS

Hereinafter, with reference to the accompanying drawings, it will be explained in detail of aspherical microlens arrays, a fabricating method therefor and applications using the same in accordance with preferred embodiments of the present invention.

It will be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

It will now be described in detail about aspherical microlens arrays in accordance with an embodiment of the present invention with reference to attached drawings.

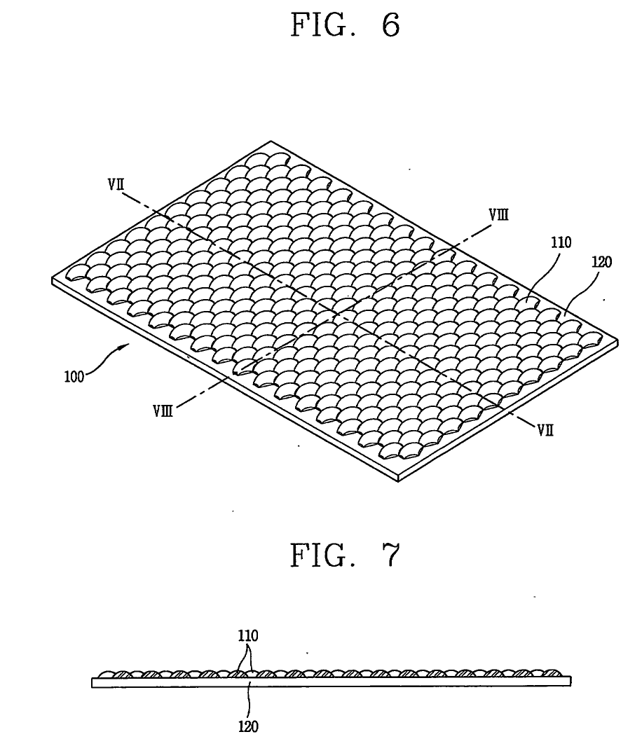

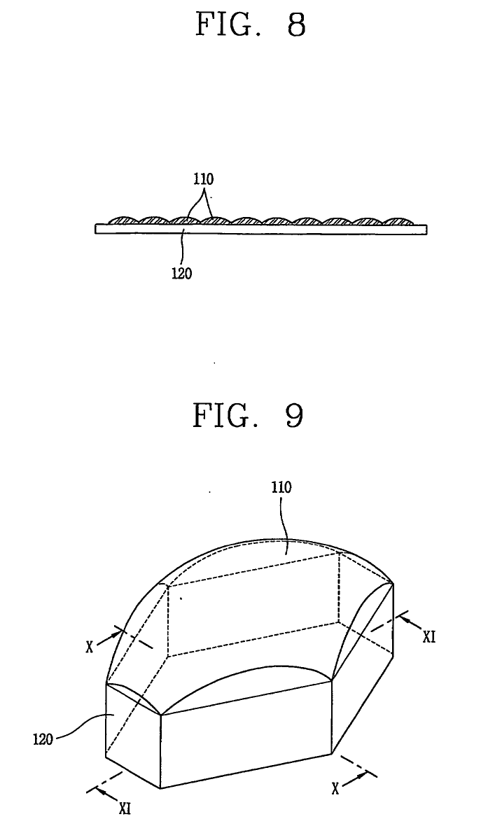

FIGS. 6 through 8 illustrate aspherical microlens arrays in accordance with preferred embodiments of the present invention. FIG. 6 is a perspective view showing the aspherical microlens arrays in accordance with an embodiment of the present invention, FIG. 7 is a cross-sectional side view, taken along cross-sectional line VII-VII of FIG. 6 and FIG. 8 is a cross-sectional side view, taken along cross-sectional line VIII-VIII of FIG. 6.

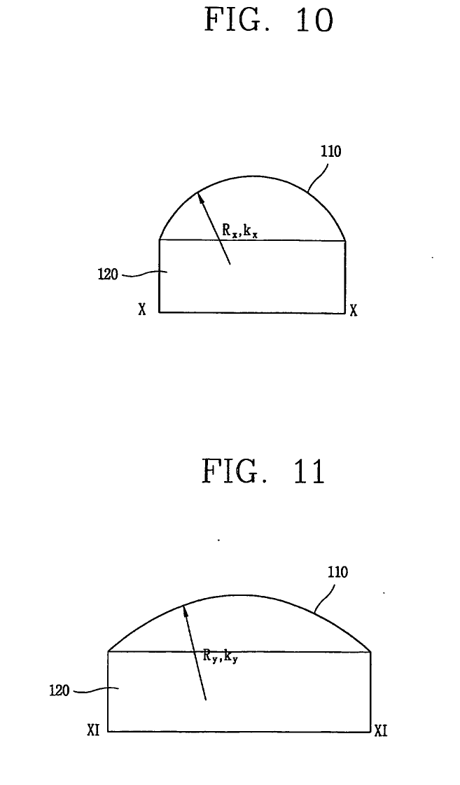

Also, FIG. 9 illustrates a unit microlens in accordance with an embodiment of the present invention, FIG. 10 is a side view, taken along cross-sectional line X-X of FIG. 9, and FIG. 11 a cross-sectional side view, taken along cross-sectional line XI-XI of FIG. 9.

As shown in those drawings, an aspherical microlens arrays 100 in accordance with an embodiment of the present invention includes a base 120 and a plurality of aspherical microlenses 110 arranged on the base 120.

A thickness of the base 120 depends on a focal length of collimated beam concentrated by a curved surface of the aspherical microlens a 110.

In addition, the base is preferably formed of a transparent resin to transmit beam, and it can be formed of glass.

As shown in FIGS. 9 and 10, the aspherical microlenses 110 have different curvature radiuses and conic coefficients, respectively, along two axes (a direction of X-X and a direction of XI-XI of FIG. 9) orthogonal to each other on a base 120 perpendicular to an optical axis. That is, the aspherical microlens 110 has different curvature radiuses Rx and Ry, and also has different conic coefficients Kx and Ky along the two orthogonal axes.

In more detail, the aspherical microlens 110 is formed in a prolate ellipse shape of which conic coefficient takes the range between −1 and 0 (zero) along one axis of the two orthogonal axes, while it is formed in an oblate spheroid shape of which conic coefficient is more than 0 (zero) along another axis orthogonal to the one axis.

That is, in the microlens 110, the curvature radius is independently adjusted respectively along the orthogonal axes, so that the angular field of view can be optionally adjusted.

Similar to this, because the microlens 110 is formed to have different aspherical coefficients respectively along orthogonal axes, a spherical aberration can be reduced compared with the conventional spherical microlens, concentration efficiency can be enlarged, and a numerical aperture (NA) of lens can be optimized according to each direction of an angular field of view.

These plurality of aspherical microlenses 110 are arranged on the base 120 having a certain thickness. At this time, the aspherical microlens 110 can be formed separately from or integrally with the base 120.

In addition, a size of the aspherical microlens 110 is determined by a minimum expression resolution of a picture display device, a size of the microlens 110 is defined at a range of several micrometers through hundreds of micrometers in a direction of a diameter of lens, and a sag height of the microlens 110 is relative to the diameter thereof. In particular, in case of a projection image display device using a liquid crystal display (LCD) or a light processor (DLP) as an image source, the smaller the aspherical microlens 110 is the more a screen deterioration effect such as a Moire interference pattern can be decreased, so that it is preferable to fabricate a size of the aspherical microlens 110 as small as possible.

Here, the plurality of microlenses 110 are preferably arranged on the base to have a hundred percent of packing fraction. That is, preferably, the aspherical microlenses 110 are closely packed and arranged together in order not to make any space therebetween. In addition, it is possible to form an additional film having a certain thickness on the aspherical microlenses 110 for filling an interval therebetween.

A footprint shape of the aspherical microlens 110, on the other hand, is preferably one of a triangle, a square and a hexagon.

In addition, the aspherical microlenses 110 are preferably arranged as a honeycomb shape on the base 120 but it is also possible to arrange them to be orthogonal together.

Hereinafter, it will be described about a method for fabricating an aspherical microlens arrays in accordance with an embodiment of the present invention.

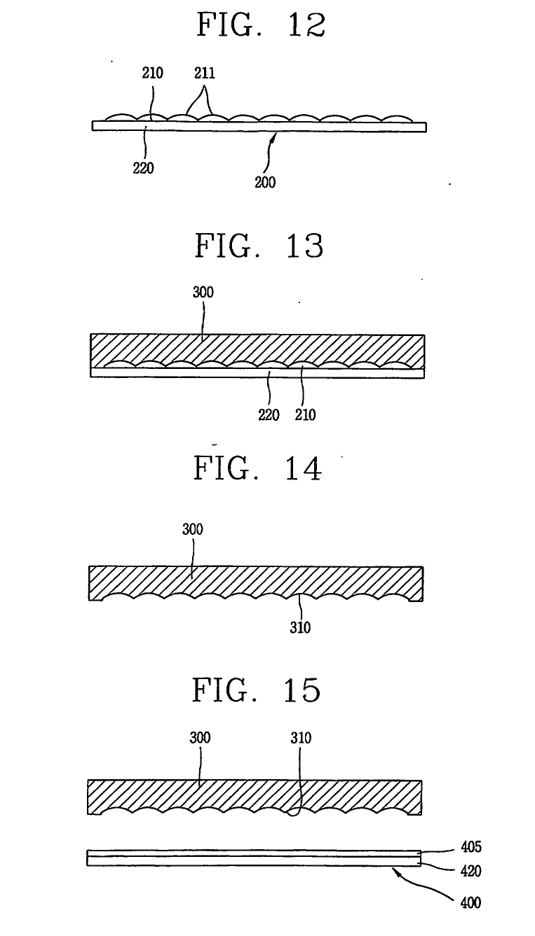

FIGS. 12 through 21 illustrate a method for fabricating an aspherical microlens arrays in accordance with an embodiment of the present invention.

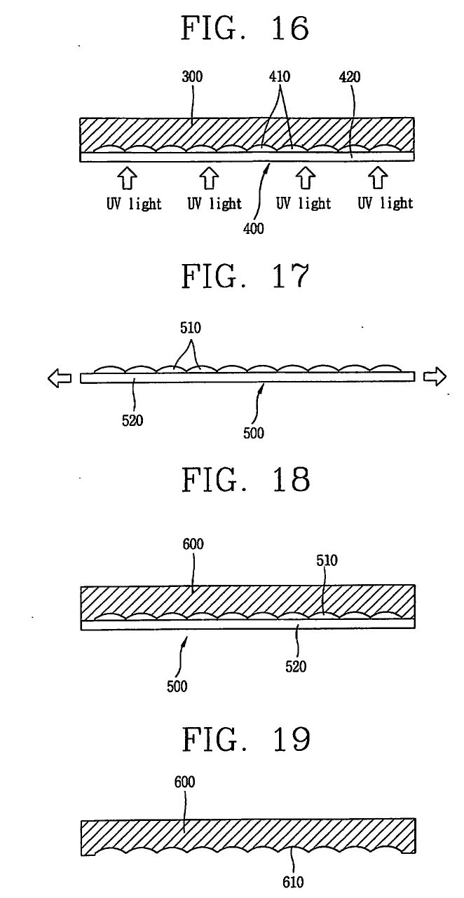

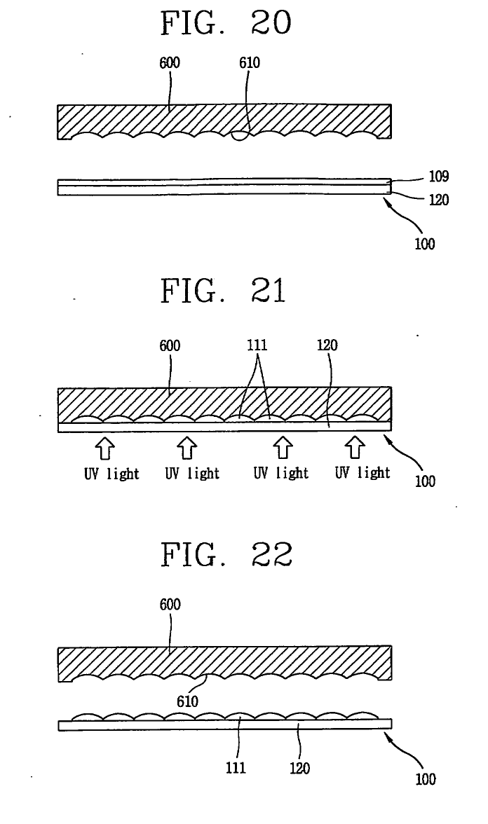

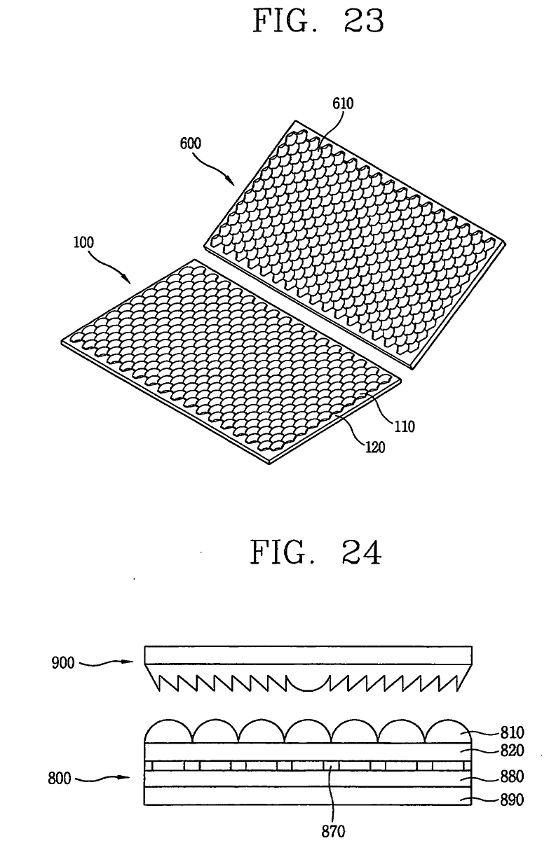

As shown in those drawings, a method for fabricating an aspherical microlens arrays in accordance with an embodiment of the present invention includes: a first step of fabricating a first mold 300 having a spherical groove arrays 310 with respectively different curvature radiuses along two orthogonal axes on a certain surface (refer to FIGS. 12 through 14); a second step of fabricating an elastically-deformable spherical microlens arrays 400 by using the first mold 300 (refer to FIGS. 15 and 16); a third step of fabricating an aspherical microlens arrays 500 having respectively different curvature radiuses Rx and Ry and conic coefficients Kx and Ky along the two orthogonal axes on the certain surface by providing elongated force to the elastically-deformable spherical microlens arrays 400 (refer to FIG. 17); a fourth step of fabricating a second mold 600 having on its certain surface an aspherical groove arrays 610 which is a reversed phase of the aspherical microlens arrays 500 (refer to FIGS. 18 and 19); and a fifth step of reproducing the aspherical microlens arrays 100 by using the second mold 600 (refer to FIGS. 20 through 23).

Each step will be explained in more detail as follows.

The first step of fabricating the first mold 300 includes the steps of: fabricating a spherical microlens arrays 200 on which spherical microlenses 211 having different curvature radiuses, respectively, along two orthogonal axes on a certain plane surface of the base 220 are arranged (refer to FIG. 12); fabricating the first mold 300 having the spherical groove shape 310 which is the reversed phase of the spherical microlenses 211, by plating a metal on a certain surface of the base 220 on which the spherical microlenses 211 are formed (refer to FIG. 13); and releasing or removing the spherical microlens arrays 200 from the first mold 300 (refer to FIG. 14).

Here, the spherical microlens arrays 200 are generally fabricated as follows. That is, after coating a photoresist or a photosensitive polymer on the base 220, a process for patterning a microlens arrays shape is performed through a lithography technology. Thereafter, a spherical shape of the microlens 211 is adjusted depending on a reflow technology using a thermal processing. Also, in addition to the lithography technology, other technologies can be used to fabricate the spherical microlens arrays.

On the other hand, nickel is preferably used as the metal to be plated, namely, a material of the first mold 300, and a seed layer is preferably first deposited prior to plating.

Furthermore, the second step includes the steps of: forming an elastically-deformable resin layer 405 on one surface of the elastically-deformable base 420; compressing the resin layer 405 on one surface of the first mold 300 at which the spherical groove arrays 310 has formed and thus forming spherical microlenses 410 on the resin layer 405; hardening the resin layer 405 on which the spherical microlenses 410 have been formed through an ultraviolet applying or a heating; and releasing the spherical microlens arrays 400 from the first mold 300.

On the other hand, in the third step, once providing elongated force toward a certain axial direction (namely, XI-XI direction of FIG. 9) at the base of the elastically-transformable spherical microlens arrays 400, compression force is provided toward an axial direction orthogonal to the certain axial direction. At this time, each spherical microlens has different curvature radiuses Rx and Ry and different conic coefficients Kx and Ky depending on the two orthogonal axes, and accordingly the aspherical microlens arrays 500 formed of the elastic resin is fabricated.

In general, in an elastic solid, a ratio of an elongated strain by an external elongated force applied to a specific direction and a constrictional strain induced to another axial direction orthogonal to the specific direction corresponding to the elongated strain is called as Poisson's Ratio. This Poisson's Ratio is also applied to the case of deforming the spherical microlens arrays 500 formed of an elastically-deformable material by the external elongated force. That is, in the process for deforming it to an aspherical shape by the external elongated force as described in the third step, a certain elongated strain is generated by having an elastic coefficient, namely, a material feature of a fine structure such as the base 520 and the microlens 510, as a proportional constant. In other words, corresponding to the elongated strain of the base 520, the elongated strain of the microlens 410 having a certain curvature radius along the direction (namely, XI-XI direction of FIG. 9) on which the elongated force is acted is also generated. Thus, the microlens 410 can have new curvature radius Ry and conic coefficient Ky along the direction (namely, XI-XI direction of FIG. 9). Here, Ky is greater than zero. Also, simultaneously therewith, a shrinkage stress is acted along a direction (namely, X-X direction of FIG. 9) orthogonal to the direction (XI-XI direction of FIG. 9) on which the elongated force is acted, and accordingly a constrictional strain is also carried out for the microlens 410 having the certain curvature radius along the direction (X-X direction). As a result, the microlens 410 can have new curvature radius Ry and conic coefficient Kx along the direction (X-X direction). Here, Kx is greater than −1 and smaller than zero.

At this time, a size of the conic coefficient is determined relatively to a degree of the elongated strain and the constrictional strain. That is, the aspherical shape of the microlens 510 can be deformed to correspond to various ranges of numerical aperture (NA) by having a reproductivity within an elastic deformation limit of a material forming the initial elastic spherical microlens arrays 500 and by adjusting a degree of its deformation.

The fourth step, on the other side, includes the steps of plating a metal on the aspherical microlens arrays 500 fabricated through the third step and accordingly fabricating a second mold which a reversed phase of the aspherical microlenses is transcribed on one surface thereof; and releasing the aspherical microlens arrays 500 from the second mold.

Nickel is used as the metal to be plated, it is preferable to deposit the seed layer first before plating.

Furthermore, the fifth step includes the steps of: forming a molding layer 109 on a certain surface of the base 120; compressing the molding layer 109 on a certain surface of the second mold 600 on which the aspherical groove arrays 610 has been formed and accordingly forming aspherical microlenses 111 on the molding layer 109; hardening the molding layer 109 on which the aspherical microlenses 111 have formed through an ultraviolet applying or a heating; and releasing the aspherical microlens arrays 100 from the second mold 600.

That is, it is possible to reproduce the same shape of aspherical microlens arrays 100 by repeating the fifth step using the second mold 600.

On the other side, the base 120 of the aspherical microlens arrays 100 and a refractive index of the microlenses 111 can be varied by applying appropriate materials suitable for an optical characteristic to be required. Preferably, transparent resin or glass can be usually used as the material.

Hereinafter, it will be described about applications using the aspherical microlens arrays in accordance with an embodiment of the present invention.

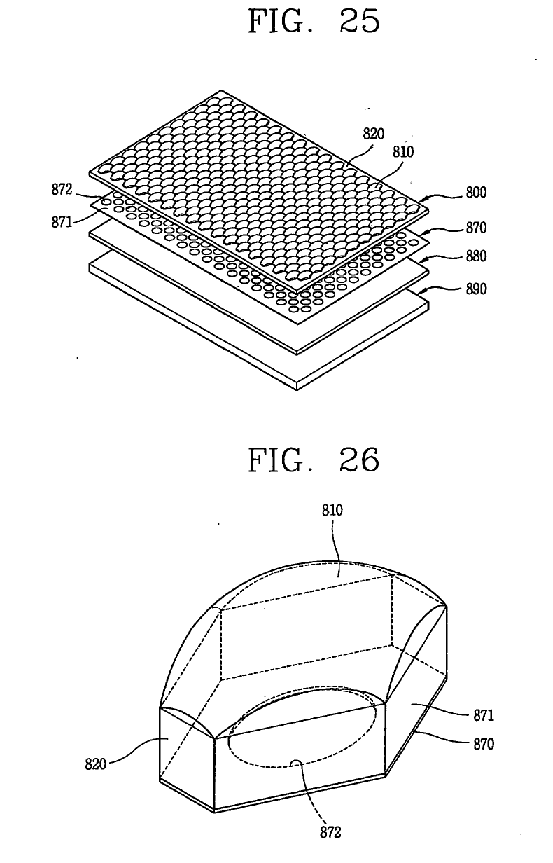

FIG. 24 is a schematic diagram illustrating a projection screen to which the aspherical microlens arrays in accordance with an embodiment of the present invention is applied, FIG. 25 is a disassembled perspective view illustrating an aspherical microlens arrays assembly applied to a projection screen, and FIG. 26 is a perspective view illustrating an aspherical unit microlens applied to the projection screen.

As shown in those drawings, a projection screen to which the aspherical microlens arrays in accordance with an embodiment of the present invention is applied includes: an aspherical microlens arrays 800 having a plurality of aspherical microlenses 810 arranged on the base 820; a black matrix layer 870 formed on an opposite surface to the one surface of the base 820 on which the microlenses 810 have been formed and having an arrays structure of a clear aperture 872 corresponding to the respective microlenses 820; and Fresnel lenses 900 installed at a position facing the microlenses 810, and accordingly transcribing collimated beam to the microlens arrays 800.

Here, the aspherical microlens arrays 800 is the same as the aspherical microlens arrays 100 of the present invention in its structure and characteristics so as to omit a detailed explanation thereof.

The black matrix layer 870 consists of a plurality of clear apertures 872 formed at a circumference of an optical axis Z and a light cutoff portion 871 formed of an opaque black matrix surrounding the clear apertures 872.

The black matrix layer 870 is formed by the following processes.

That is, a photosensitive black matrix is formed on the other surface of the base 820 surface on which the aspherical microlens 810 has been formed by performing a lamination and a coating. Thereafter, when collimated light is applied onto a curved surface of the aspherical microlens 810, the light refracted when it passes through the aspherical microlens 810 is concentrated into a circumferential area of the optical axis Z. As a result, the part of the area is exposed. In addition if a part of the black matrix which has been exposed and then deformed is removed by such a development, the clear apertures 872 are formed, to which the collimated light incident on the microlens 110 is then transmitted. At the same time to this, the remaining parts without being removed at the developing process become the light cutoff portion 871.

The fabricating method for the clear apertures 872 takes a self-alignment system. Accordingly, unlike the conventional system for assembling the aspherical microlens arrays 800 and a clear aperture arrays layer, there is not required for an additional alignment process. It is thus advantageous to reduce costs required for the fabricating processes and to simplify the fabricating processes.

The projection screen to which the aspherical microlens arrays 800 of the present invention is applied, as aforementioned, can adjust a conic coefficient of the microlens 810 depending on directions horizontal and perpendicular to an earth surface. That is, the conic coefficient of the microlens 810 is adjusted between −1 and zero along the horizontal direction so as to enlarge a refracting angle, namely, the numerical aperture (NA). In response to this, the angular field of view can be widened. Furthermore, the conic coefficient is adjusted greater than, zero along the perpendicular direction so as to make the refracting angle, namely, the conic coefficient small. According to this, it is possible to ensure an angular field of view as much as being required toward the perpendicular direction. As a result, it is possible to guarantee a certain angular field of view in the perpendicular direction without deterioration of image quality due to a reduction of brightness of the horizontal direction, namely, deterioration of the brightness a Moire interference pattern, or the like.

That is, compared with the conventional spherical microlens arrays, it is advantageous to reduce a spherical aberration, increase a concentration efficiency, optimize the angular field of view of the directions horizontal and perpendicular to the earth surface and improve an optical efficiency, contrast and resolution.

On the other hand, the projection screen to which the aspherical microlens arrays according to the present invention is applied further includes an optical scattering layer 880 in order to degrade deterioration of image quality due to an increase of an additional angular field of view and glittering.

The optical scattering layer 880 is bonded to one surface of the black matrix layer 870 on which the clear aperture 872 is formed.

However, the optical scattering layer 880 does not have to be installed additionally because a sufficient angular field of view can be ensured by the aspherical microlens arrays 800 and the deterioration of the image quality can be prevented.

Also, the projection screen further includes a supporting layer 890 for increasing stiffness of the screen and protecting components such as the microlens arrays 800 from the external impact.

The supporting layer 890 is bonded to one surface of the black matrix layer 870 or the optical scattering layer 880, and it is also preferably formed of a transparent material to enable light to be transmitted.

Hereinafter, it will be described about an image sensor to which the aspherical microlens arrays in accordance with an embodiment of the present invention is applied.

The image sensor refers to an apparatus for detecting subject information and converting it into an electrical video signal.

Although not shown in drawings, the image sensor to which the aspherical microlens arrays according to the present invention is applied includes: an image processing unit; and an aspherical microlens arrays coupled to one side of the image processing unit and having a plurality of aspherical microlenses arranged on the base, for improving a degree of integration of light incident onto the image processing unit.

That is, the microlens arrays is alignedly-bonded to an imaging device in order for a focusing area of each lens of the aspherical microlens arrays to be included in a light receiving portion of the imaging device of the image processing unit so as to converge light applied to other areas rather than to the focusing area of the imaging device, to the focusing area. As a result of this, it is possible to improve an optical efficiency and sensitivity of the image sensor.

Here, the aspherical microlens arrays has the same structure and characteristics as the aspherical microlens arrays 100 in accordance with the embodiment of the present invention, so that a detailed explanation thereof will be omitted.

Additionally, as the image sensor to which the aspherical microlens arrays according to the present invention is applied, there are a bolometer arrays, an infrared imager, a charge coupled device (CCD) or a complementary metal oxide semiconductor (CMOS).

Furthermore, the aspherical microlens arrays according to the present invention may be applied to other various image sensors.

Accordingly, it is advantageous to improve sensitivity and resolution of the image sensor by applying the aspherical microlens arrays according to the present invention to the image sensor.

As stated so far, the aspherical microlens arrays according to the present invention can optionally adjust the curvature radius and the conic coefficient along two orthogonal axes on a plane surface perpendicular to the optical axis. In response to this, a degree of infraction of an optical system, namely, a numerical aperture is easily adjusted according to each axial direction, and a spherical aberration is decreased and concentration efficiency is increased with comparison to the conventional spherical microlens arrays.

In addition, in the aspherical microlens arrays according to the present invention, a certain elongated force is provided to the spherical microlens arrays, by which a mold is fabricated. By using the mold, a mass reproduction of the aspherical microlens arrays can be facilitated and accordingly fabricating costs will be reduced.

Furthermore, if the aspherical microlens arrays according to the present invention is applied to the projection screen, it is possible to optionally adjust the angular field of view of directions perpendicular and horizontal to the earth surface and to optimize an optical efficiency. That is, it is possible to ensure a certain angular field of view in a perpendicular direction without deterioration of image quality due to reduction of brightness of a horizontal direction, namely, deterioration of brightness, a Moire interference pattern or the like by adjusting the curvature radius and conic coefficient of the aspherical microlens along the perpendicular and horizontal directions. According to this, contrast and resolution can be also improved.

In addition, because the aspherical microlens arrays according to the present invention is applied to the projection screen the optical scattering layer does not have to be installed for degrading an increase of an additional angular field of view and the deterioration of image quality. As a result of this, it is available to minimize the projection screen and reduce costs.

Moreover, the aspherical microlens arrays can be minimized, which is advantageous to improve resolution. In response to this, it is possible to easily correspond to a high definition of a display.

The aspherical microlens arrays according to the present invention can be coupled to the light receiving portion of the imaging device of the image sensor such as the charge coupled device (CCD) or the complementary metal oxide semiconductor (CMOS), or the imager array, and accordingly it is possible to improve the optical efficiency, sensitivity and resolution of the image sensor.

1. Aspherical microlens arrays comprising:
a base: and
a plurality of aspherical microlenses arranged on the base.

2. The arrays of claim 1, wherein the microlenses have respectively different curvature radiuses and conic coefficients along two orthogonal axes on the base perpendicular to an optical axis.

3. The arrays of claim 2, wherein the microlens is formed in a prolate ellipse shape of which conic coefficient takes the range between −1 and 0 (zero) along one axis of the two orthogonal axes, while the microlens is formed in an oblate spheroid shape of which conic coefficient is more than 0 (zero) along another ads orthogonal to the one axis.

4. The arrays of claim 1, wherein the microlenses preferably arranged on the base to have a hundred percent of packing fraction.

5. The arrays of claim 1, wherein the footprint of the microlens has a triangular shape.

6. The arrays of claim 1, wherein the footprint of microlens has a square shape.

7. The arrays of claim 1, wherein the footprint of the microlens has a hexagonal shape.

8. The arrays of claim 1, wherein the base is formed of a transparent resin.

9. The arrays of claim 1, wherein the base is formed of glass.

10. The arrays of claim 1, wherein the microlenses are arranged as a honeycomb shape.

11. The arrays of claim 1, wherein the microlens has a size of several microns to hundreds of microns.

12. A method for fabricating aspherical microlens arrays, the method comprising:
a first step of fabricating a first mold having spherical groove arrays with different curvature radiuses, respectively, along two orthogonal axes on one surface,
a second step of fabricating spherical microlens arrays capable of an elastic deformation using the first mold;
a third step of fabricating aspherical microlens arrays having different curvature radiuses and conic coefficients, respectively, along two orthogonal axes on one surface of the microlens arrays by providing elongated force to the elastically-deformable spherical microlens arrays;
a fourth step of fabricating a second mold having aspherical groove arrays, namely, a reversed phase of the aspherical microlens arrays on one surface thereof; and
a fifth step of reproducing the aspherical microlens arrays using the second mold.

13. The method of claim 12, wherein the first step includes the steps of:
fabricating spherical microlens arrays on which spherical microlenses having different curvature radiuses, respectively, along two orthogonal axes on a certain plane surface of a base are arranged;
fabricating the first mold having the spherical groove arrays which is the reversed phase of the spherical microlens arrays, by plating a metal on the surface of the base on which the spherical microlenses have been formed; and
releasing or removing the spherical microlens arrays from the first mold.

14. The method of claim 13, wherein the spherical microlens is formed by a reflow technology.

15. The method of claim 13, wherein the metal to be plated is nickel.

16. The method of claim 12, wherein the second step includes the steps of:
forming an elastically-deformable resin layer on one surface of the elastically-deformable base;
compressing the resin layer on one surface of the first mold at which the spherical groove arrays have formed and thus forming spherical microlenses on the resin layer;
hardening the resin layer on which the spherical microlenses have been formed; and
releasing the spherical microlens arrays from the first mold.

17. The method of claim 16, wherein the resin layer is hardened through an ultraviolet applying or a heating.

18. The method of claim 12, wherein in the third step, an elongated strain is generated in a certain axial direction of the microlens to which the elongated force has been provided, and compression force is provided to an axial direction orthogonal to the certain axial direction, thereby simultaneously generating a constrictional strain.

19. The method of claim 12, wherein the fourth step includes the steps of:
plating a metal on the aspherical microlens arrays fabricated through the third step and accordingly fabricating a second mold which a reversed phase of the aspherical microlenses is transcribed on one surface thereof; and
releasing the aspherical microlens arrays from the second mold.

20. The method of claim 19, wherein the metal to be plated is nickel.

21. The method of claim 12, wherein the fifth step includes the steps of:
forming a molding layer on a certain surface of a base;
compressing the molding layer on a certain surface of the second mold on which the aspherical groove arrays has been formed and accordingly forming aspherical microlenses on the molding layer;
hardening the molding layer on which the aspherical microlenses have formed; and
releasing the aspherical microlens arrays from the second mold.

22. The method of claim 21, wherein the base is formed of transparent resin or glass.

23. The method of claim 21, wherein the molding layer is transparent resin or glass.

24. The method of claim 21, wherein the molding layer is hardened through an ultraviolet applying or a heating.

25. A projection screen comprising:
an aspherical microlens arrays having a plurality of aspherical microlenses arranged on a base;
a black matrix layer formed at an opposite surface to the certain surface of the base at which the microlenses have been formed and having an array structure of a clear aperture corresponding to the respective microlenses; and
a Fresnel's lens installed at a position facing the microlens, for applying collimated beam to the microlens array.

26. The projection screen of claim 25, wherein the aspherical microlenses have different curvature radius and conic coefficient, respectively along two orthogonal axes on the base perpendicular to an optical axis.

27. The projection screen of claim 26, wherein the aspherical microlens arrays are formed in a prolate ellipse shape of which conic coefficient takes the range between −1 and 0 (zero) along one axis of the two orthogonal axes, while the microlens is formed in an oblate spheroid shape of which conic coefficient is more than 0 (zero) along another axis orthogonal to the one axis.

28. The projection screen of claim 27, wherein the conic coefficient of the aspherical microlens is adjusted between −1 and 0 (zero) along a direction horizontal to an ground surface and adjusted greater than 0 (zero) along a direction perpendicular to the ground surface, and accordingly an angular field of view is widened in the horizontal direction and also a certain angular field of view is ensured in the perpendicular direction with preventing reduction of brightness.

29. The projection screen of claim 25, wherein the black matrix layer consists of a plurality of clear apertures formed at a circumference of an optical axis and a light cutoff portion formed of an opaque black matrix surrounding the clear apertures.

30. The projection screen of claim 25, wherein the black matrix layer is formed by a self-alignment system through the steps of:
forming a photosensitive black matrix on the other surface of the base surface on which the aspherical microlenses have been formed;
concentrating light refracted when the light passes through a curved surface of the aspherical microlenses into a circumferential area of an optical axis and exposing the area; and
removing a part of the black matrix where has been exposed and deformed through a development, thereby forming the clear apertures.

31. The projection screen of claim 25, further including an optical scattering layer bonded on a certain surface of the black matrix layer for degrading an increase of an additional angular field of view and deterioration of image quality.

32. The projection screen of claim 25, further including a supporting layer for improving stiffness and protecting components such as the microlens array from an external impact.

33. An image sensor comprising:
an image processing unit; and
an aspherical microlens arrays coupled to one side of the image processing unit and having a plurality of aspherical microlenses arranged on a base, for improving a degree of integration of light incident onto the image processing unit.

34. The image sensor of claim 33, wherein the aspherical microlens arrays have different curvature radius and conic coefficient, respectively, along two orthogonal axes on the base perpendicular to an optical layer.

35. The image sensor of claim 33, wherein the image sensor is one of an infrared imager, a bolometer array, a charge coupled device (CCD) or a complementary metal oxide semiconductor (CMOS).
